(19) United States
(12) Patent Application Publication
(10) Pub. No.: US 2015/0179067 A1
(43) Pub. Date: Jun. 25, 2015

(54) METHOD FOR DELIVERING A WARNING OF A HAZARDOUS ROAD SURFACE STATE AND APPARATUS

(71) Applicant: Hella KGaA Hueck & Co., Lippstadt (DE)

(72) Inventors: Carsten THUN, Bremen (DE); Ole MORISSE, Bremen (DE)

(21) Appl. No.: 14/581,419

(22) Filed: Dec. 23, 2014

(30) Foreign Application Priority Data
Dec. 23, 2013 (DE) 102013021797.0

(51) Int. Cl. G08G 1/0967; E01F 9/00; E01C 11/24

(52) U.S. Cl. CPC G08G 1/0967; E01C 11/24; E01F 9/005

(57) ABSTRACT

In a method for delivering a warning of a hazardous road surface state for application in a travelling motor vehicle in which the air temperature is measured, a targeted prediction of the road surface state is to be made so that the output of a warning can be avoided in many cases in which such a warning was not objectively justified. This is achieved by means of a contactless measurement method by which means the moisture of the road surface is determined and by means of which the temperature of the road surface is determined where a value describing the road surface state is determined taking into account these three measured values. The warning is then delivered depending on the value describing the road surface state.

### BACKGROUND OF THE INVENTION

1. Field of the Invention

The invention relates to a method for delivering a warning of a hazardous road surface state for application in a travelling vehicle in which the air temperature is measured. The invention further relates to an apparatus, in particular for carrying out this method, comprising a temperature measuring device for measuring the air temperature.

2. Brief Discussion of the Related Art

Such a method is generally known in motor vehicles. When the ambient temperature falls below a certain value, typically below 4° C., it is fundamentally possible that with rapidly varying local ambient temperatures, for example, in bridge regions, ice can form on the road surface there. As a result of the measured air temperature or ambient temperature, a warning is then delivered to the driver which draws his attention to the fact that a slippery road surface can possibly be expected. This method has an indicative character and therefore for safety reasons engages in a quite overwhelming number of cases when there is no actual hazard. This can result in a tendency which causes the driver to disregard such a warning.

In U.S. Pat. No. 4,274,091 it has been proposed to detect the presence of ice on a road surface with the aid of a light signal and the reflection thereof. If the emitted light is reflected at the road surface and then received accordingly by a receiver, the presence of ice can thus be concluded. An appropriate warning is then output. A comparable sensor device for contactless detection of states of a surface is known from EP 1 606 784 B1. In this sensor device, light is directed onto a surface by means of a light source and diffusely reflected and specularly reflected light is detected by means of two detectors. The presence of snow, ice or water is concluded from the data of the reflected light thus obtained.

### SUMMARY OF THE INVENTION

It is the object of the invention to provide a method of the type mentioned initially by which means a targeted prediction of the road surface state can be made so that the output of a warning can be avoided in many cases in which such a warning was not objectively justified. It is further the object of the invention to provide a corresponding apparatus.

This object is solved by a method having the features of patent claim 1. The object is solved in terms of apparatus by the features of patent claim 10.

In a method for delivering a warning of a hazardous road surface state for application in a travelling motor vehicle in which the air temperature is measured, it is provided according to the invention that the moisture of the road surface is determined by means of a first contactless measurement method, that the temperature of the road surface is determined by means of a second contactless measurement method, that a value describing the road surface state is determined taking into account these three measured values and that the warning is delivered depending on the value describing the road surface state. In contrast to the previously known method, therefore not only a single measured value, in particular not only the air temperature or ambient temperature, is taken as the basis but in addition another two measured values are determined, namely a measured value which describes the moisture of the road surface and a measured value which describes the temperature of the road surface. A value describing the road surface state is determined from these three measured values. This value in particular takes into account the possible presence or ice or slipperiness. This is the most relevant hazard parameter for driving. When there is a high probability of the presence of ice, a corresponding warning is delivered. This can be of a visual or audible nature. In certain cases, the warning can be delivered both visually and audibly.

In a preferred embodiment of the invention, the moisture of the road surface is measured by means of a capacitive method. For this purpose a measuring electrode is disposed substantially parallel to the road surface. The measuring electrode and the counter surface form an electrical capacitor whose capacitance varies due to the presence of moisture on the road surface. In principle, the use of such capacitive sensors is known. For example, a rain sensor with capacitive sensors is described in EP 2 218 616 B1.

The temperature of the road surface is preferably measured by means of a thermophilic measuring element. A measurement method directed onto the surface is used in this case. The temperature of the road surface is preferably measured by means of an infrared sensor. In such an infrared sensor the infrared radiation emanating from the road surface is measured and from this the temperature of the road surface is concluded. In a particularly preferred embodiment the infrared sensor is an infrared camera. Preferably such an infrared camera is combined with a camera in the visible wavelength range. The images thus produced are superposed and from this information on the temperature of the road surface and possibly also other data are obtained. Preferably an active pixel sensor which is also designated as a CMOS sensor is used here.

The infrared sensor is preferably aligned forwards in the direction of travel, in particular so that the area covered lies approximately two to five metres in front of the vehicle. As a result, a preliminary detection of the road surface state is possible and in the time in which the vehicle covers the pre-measured section, a warning can be produced in the meantime or an adaptation of the motor vehicle control can be made, such as for example, adaptation of the ESP control. In addition, another measurement is preferably made in a second region which preferably, when viewed in the direction of travel, covers a length of less than 1 m, in particular of 0.5 m, and is aligned below the vehicle. This measurement is used for monitoring and confirming the data obtained from the first measurement area in front of the vehicle.

In another preferred embodiment of the invention, the measured values are each subjected to a signal processing before the value describing the road surface state is determined from the measured values. In particular, a signal conditioning is accomplished so that a common value describing the road surface state can be calculated from the signals and measured values.

In a preferred embodiment of the invention, the vehicle speed is also taken into account when determining the value describing the road surface state. The vehicle speed can possibly have an influence on the individual measurement results so that the vehicle speed is preferably taken into account. Alternatively and/or additionally the vehicle speed can also be taken into account when issuing the warning. If a relatively high vehicle speed is determined for a specific value describing the road surface state, the overall hazard resulting therefrom is higher than at a lower vehicle speed. Preferably the vehicle speed is therefore taken into account in addition to the value describing the road surface state when delivering the warning. In another preferred embodiment of the invention, the wiper signal is taken into account when determining the value describing the road surface state. By this means additional information on the moisture of the road surface can be obtained, in particular on the information about precipitation which is just beginning. In this respect, information about the time behaviour of the precipitation from the last 5 minutes or the last 10 minutes can be included in the determination of the value describing the road surface state. Furthermore it is favourable if the ESP control is taken into account when determining the value describing the road surface state. This also provides an indication of the road surface state. If the ESP control has been started up and is actively engaged, this is an indication of slipperiness or a road surface state which justifies a warning.

In another preferred embodiment of the invention, the intensity of the warning is graduated and can be delivered depending on the value describing the road surface state. This means that when there is a higher hazard, in particular higher hazard in conjunction with a higher driving speed, a stronger signal is delivered than for a lower hazard, in particular a lower hazard in conjunction with a lower driving speed. This can either be indicated by means of colour scales of a signal such as yellow and red or a flashing frequency of a signal and/or an additional or increasing audible signal.

A further aspect of the invention consists in the provision of an apparatus for delivering a warning of a hazardous road surface state, in particular for carrying out the method described above. This apparatus comprises a temperature measuring device for measuring the air temperature and is characterized as essential to the invention by the fact that the apparatus comprises a sensor for measuring the moisture of the road surface and furthermore a sensor for measuring the temperature of the road surface. Furthermore, the apparatus according to the invention comprises a data processing device which is intended and designed to determine a value describing the road surface state from the measurement data of the three sensors and to initiate a warning resulting therefrom. The delivery of the warning itself can also be made by the data processing device but is typically delivered by a display device in the viewing or hearing range of a driver of a motor vehicle. However the data processing device delivers a corresponding signal to this output device. The method described above can be carried out with such an apparatus and a value describing the road surface state can be determined reliably taking into account three different sets of measurement data.

The sensor for measuring the moisture of the road surface is preferably a capacitive sensor. This capacitive sensor is preferably disposed in the bottom area of the vehicle and in particular has a measuring electrode which is aligned substantially parallel to the road surface. Preferably at least two capacitive sensors are disposed adjacent to one another transversely to the vehicle longitudinal axis. These cover a certain width of the road surface and as a result, have a better data base for determining a reliable result.

The sensor for measuring the temperature of the road surface is preferably an infrared sensor which detects the infrared radiation emanating from the road. The infrared sensor is preferably disposed in the bottom area of the motor vehicle. The infrared sensor is preferably disposed approximately centrally, i.e. on the vehicle longitudinal axis.

### BRIEF DESCRIPTION OF THE DRAWINGS

The invention is explained further hereinafter with reference to an exemplary embodiment shown in the drawing. In detail in the schematic views:

FIG. 1 shows a schematic view of a motor vehicle with sensors provided thereon;

FIG. 2 shows a schematic view of the process sequence; and

FIG. 3 shows a schematic view of the front area of a motor vehicle with the sensor arrangement for detecting the temperature of the road surface.

### DETAILED DESCRIPTION OF THE PREFERRED EMBODIMENTS

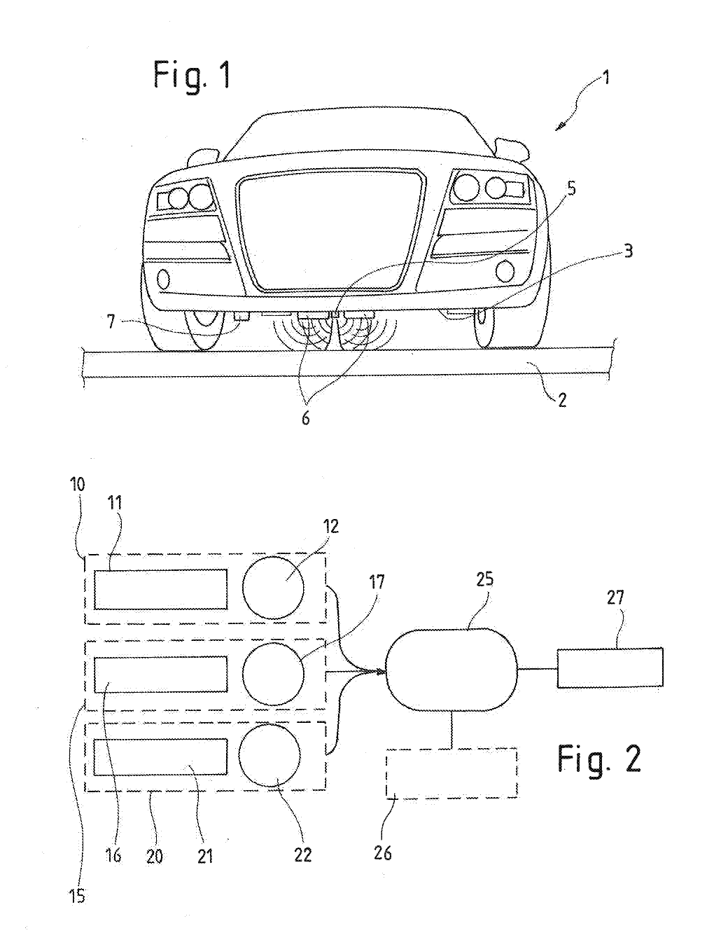

FIG. 1 shows a motor vehicle 1 travelling on a road surface 2. For determining the state of the road surface, a plurality of sensors are disposed in the area of the bottom 3 of the motor vehicle 1, i.e. on its underside and aligned towards the road surface 2. Essentially this is an infrared sensor 5 which measures the infrared radiation emanating from the road surface 2 and calculates the temperature from this. The infrared radiation emanating from the road surface 2 is indicated schematically here. The infrared sensor 5 is here disposed on the vehicle longitudinal axis. Furthermore, two capacitive sensors 6 are disposed here, which are disposed adjacent to one another on both sides of the vehicle longitudinal axis. These jointly form an electric field where the road surface 2 forms the second part of the capacitor. The capacitance of the capacitor varies with the road surface state. In this case, it is substantially assumed that the distance is constant. Furthermore, the temperature measuring device 7 is provided here to measure the air temperature. In the exemplary embodiment shown here this is also disposed in the area of the bottom 3 of the motor vehicle 1. However, this temperature measuring device 7 can, in principle, be disposed at any position of the motor vehicle 1 since measurement of the ambient temperature is involved here.

FIG. 2 shows the method. Firstly in a block 10 in step 11 the temperature of the road surface is detected. This is accomplished by means of the infrared sensor 5 shown in FIG. 1. This is followed by a signal conditioning 12. In the block 15 the moisture of the road surface 2 is detected. The actual measurement is made in the block 16. The measurement is made by means of the capacitive sensors 6. This is followed by a signal conditioning 17. In the block 20 the air temperature of the surroundings is measured in the block 21 shown there. This is then followed by a signal conditioning 22. From the data determined in the three blocks 10, 15 and 20, the value describing the road surface state is determined in block 25. This can include, as indicated by block 26, further data such as, for example, the vehicle speed, information from the wiper signal or information from the ESP control. Starting from this, a warning is delivered from block 25. This in particular comprises an optical signal delivered to the instrument. This can also include a signal on the adhesion state of the road. The visual signal can either contain additional information due to colour intensity or a flashing frequency or it is also feasible that, in addition to a general warning, for example, a relative value describing the adhesion state between 0 and 100 is given, where 100 for example describes an optimal adhesion state and 0 describes complete icing.

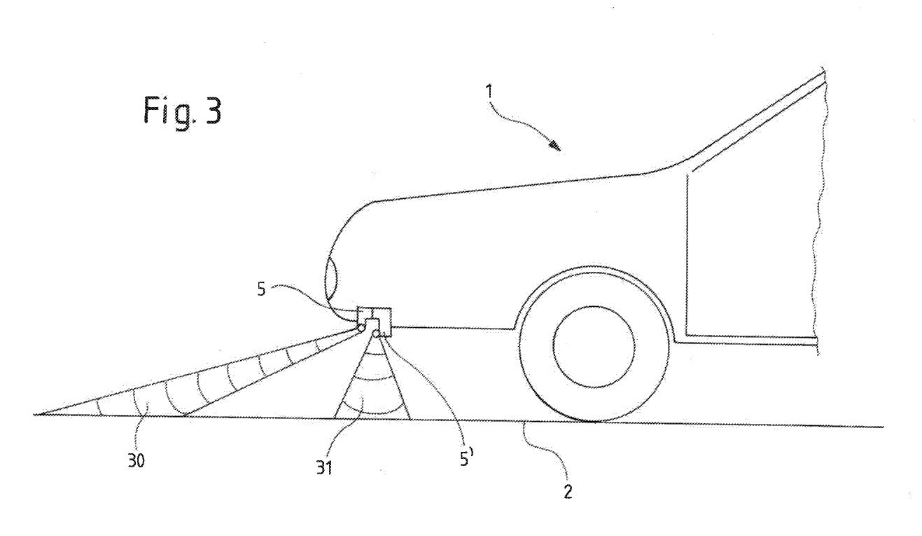

FIG. 3 shows the motor vehicle 1 travelling on the road surface 2 in side view. In the embodiment shown here, the infrared sensor 5, which particularly preferably can be an infrared camera, is designed with two different regions. In the embodiment shown here, this is configured with two infrared sensors, namely an infrared sensor 5 and a second infrared sensor 5′. The infrared sensor 5 is aligned so that, when viewed in the direction of travel, this covers a range between 2 to 5 m in front of the vehicle. In addition, an infrared sensor 5′ which is directed downwards is provided. The infrared sensor 5′ covers a second area which, when viewed in the direction of travel, covers a width of about 50 cm. This second measurement serves in particular for aligning and referencing the measurement in the first region in front of the vehicle. The infrared sensors 5 and 5′ can also be configured as a single sensor which is directed in different directions with different optics. The infrared sensors 5 and 5′ can also be configured as infrared cameras.

All the features mentioned in the preceding description and in the claims can be combined in any selection with the features of the independent claim. The disclosure of the invention is therefore not restricted to the feature combinations described and claimed, on the contrary all appropriate feature combinations within the framework of the invention should be considered to be disclosed.

1. Method for delivering a warning of a hazardous road surface state for application in a travelling motor vehicle in which the air temperature is measured, wherein,
that the moisture of the road surface is determined by means of a contactless measurement method,
that the temperature of the road surface is determined by means of a contactless measurement method,
that a value describing the road surface state is determined taking into account these three measured values and
that the warning is delivered depending on the value describing the road surface state.

2. The method according to claim 1, wherein the moisture of the road surface is measured by means of a capacitive method.

3. The method of claims 1, wherein the temperature of the road surface is measured by means of a thermophilic measuring element.

4. The method according to Claim 1, wherein the temperature of the road surface is measured by means of an infrared sensor.

5. The method according to Claim 1, wherein the three measured values are each subjected to a signal processing before the value describing the road surface state is determined from the three measured values.

6. The method according to Claim 1, wherein a vehicle speed is taken into account when determining the value describing the road surface state.

7. The method according to Claim 1, wherein a wiper signal is taken into account when determining the value describing the road surface state.

8. The method according to Claim 1, wherein an ESP control is taken into account when determining the value describing the road surface state.

9. The method according to claim 1, wherein the delivered warning additionally contains information on an adhesion state of the road.

10. An apparatus for delivering a warning of a hazardous road surface state, in particular for carrying out the method according to claim 1 comprising a temperature measuring device for measuring the air temperature,
wherein, the apparatus comprises a sensor for measuring the moisture of the road surface,
the apparatus comprises a sensor for measuring the temperature of the road surface, and the apparatus comprises a data processing device which is intended and designed to determine a value describing the road surface state from the measurement data and to initiate a warning resulting therefrom.

11. The apparatus according to claim 10, wherein the sensor for measuring the moisture of the road surface is a capacitive sensor.

12. The apparatus according to claim 11, wherein the capacitive sensor is disposed in the bottom area of the vehicle.

13. The apparatus according to claim 10, wherein at least two capacitive sensors are disposed adjacent to one another transversely to the vehicle longitudinal axis.

14. The apparatus according to claim 10, wherein the sensor for measuring the temperature of the road surface is an infrared sensor which detects infrared radiation emanating from the road.

15. The apparatus according to claim 14, wherein the infrared sensor is disposed in the bottom area of the motor vehicle.

16. A motor vehicle having an apparatus according to claim 10.
